(19) United States
(12) Patent Application Publication
(10) Pub. No.: US 2007/0065268 A1
(43) Pub. Date: Mar. 22, 2007

(54) Pallet stacking and staging system

(76) Inventor: Daniel Clapp, Great Meadows, NJ (US)

Correspondence Address: DILWORTH & BARRESE, LLP, 333 EARLE OVINGTON BLVD., SUITE 702, UNIONDALE, NY, 11553, US

(21) Appl. No.: 10/540,724

(22) PCT Filed: May 27, 2004
(86) PCT No.: PCT/US04/16730

§ 371 Date: Jun. 24, 2005

(51) Int. Cl. B08B 9/08

(52) U.S. Cl. 414/773

(57) ABSTRACT

An empty pallet stacking unit having a pallet loading and stacking end and a stacked pallet discharge end features a pallet hopper which is reversibly moveable from a pallet loading and stacking position to a stacked pallet discharging position, the pallet hopper being pivotally linked to a fixed support through a 4-bar linkage. Optionally, the empty pallet stacking unit may be cooperatively coupled to a stacked pallet staging unit.

### BACKGROUND OF THE INVENTION

1. Field of the Invention

This invention relates to a pallet stacking unit for loading and stacking a quantity of empty pallets. More particularly, the invention relates to a pallet stacking unit adapted for use with a companion stacked pallet staging unit.

2. Description of the Related Art

In warehousing and distribution facilities, there is a need for devices that will facilitate the stacking of empty pallets for pick-up and transfer to one or more remote collection points. There is also a need for a device, referred to herein as a stacked pallet staging unit, that can be cooperatively coupled to a pallet stacking device for receiving a stack of pallets discharged from the latter and retaining the stack until its removal therefrom.

US 2003/0059290 describes a pallet stacking unit possessing a generally L-shaped pallet loading and stacking component pivotable about a single pivot axis on a fixed support frame so as to assume one of two terminal positions, i.e., a pallet loading and stacking position and a stacked pallet discharge or removal position. Inherent in the design and operation of this pallet stacking unit is its need to occupy an area which is considerably greater than the area (flat side) of a pallet being stacked. It is estimated that due to the arc of travel of its pallet loading and stacking component about the single pivot axis, operation of the pallet stacking unit of US 2003/0059290 requires an area which is about 1.4 times that of a standard pallet. The need for this amount of operational area precludes deployment of the pallet stacking unit of US 2003/0059290 coupled to a stacked pallet staging unit due to the space-restricted layouts of many warehousing and distribution facilities.

### BRIEF SUMMARY OF THE INVENTION

In accordance with the present invention, there is provided an empty pallet stacking unit having a pallet loading and stacking end and a stacked pallet discharge end, the empty pallet stacking unit comprising a pallet hopper dimensioned to form and accommodate a stack of empty pallets and reversibly moveable from a pallet loading and stacking position to a pallet stack discharging position, the pallet hopper having a forward edge oriented toward the pallet discharge end of the empty pallet stacking unit, the pallet hopper being pivotally linked to a fixed support through a 4-bar linkage.

Further in accordance with the invention, the foregoing empty pallet stacking unit is combined with a stacked pallet staging unit having a stacked pallet receiving end, a stacked pallet removal end and a staging bay therebetween dimensioned to receive and retain a stack of pallets formed in the pallet hopper of the empty pallet stacking unit, the stacked pallet receiving end of the stacked pallet staging unit being cooperatively coupled to the stacked pallet discharge end of the empty pallet stacking unit such that when the pallet hopper of the empty pallet stacking unit is in the pallet stack discharging position, the stacked pallets will be discharged from the hopper into the stacked pallet staging bay of the stacked pallet staging unit and be retained in the staging bay until their removal therefrom.

Due to the compactness of the compound motion provided by the 4-bar linkage of the pallet stacking unit, such unit can be utilized in conjunction with the foregoing stacked pallet staging unit within the relatively confined space which is typical of the floor layouts of many warehousing and distribution facilities.

### BRIEF DESCRIPTION OF THE DRAWINGS

FIGS. 1A and 1B are perspective views of one side of a pallet stacking and staging system constructed in accordance with the invention and showing the pallet hopper component of the pallet stacking unit in the pallet loading and stacking position (FIG. 1A) and in the stacked pallet discharging position (FIG. 1B);

FIGS. 2A-E are diagrammatic illustrations of the pallet hopper in its pallet loading and stacking position (FIG. 2A), its intermediate positions (FIGS. 2B, 2C and 2D) and in its stacked pallet discharging position (FIG. 2E);

FIGS. 3A and 3B are perspective views of the pallet stacking system of FIG. 1A taken from its pallet loading and stacking end (pallet hopper in the pallet loading and stacking position in FIG. 3A and in the stacked pallet discharging position in FIG. 3B);

FIG. 4 is a perspective view of the pallet stacking system of FIG. 1B taken from an end of its pallet staging unit (pallet stack retention gate shown in the locked position);

FIG. 5 illustrates details of a lever mechanism for raising the flow tracks of the pallet staging unit; and,

FIGS. 6A-C illustrate details of a crank-and-rod mechanism for opening and closing the pallet stack retention gate (shown in the open position).

### DETAILED DESCRIPTION OF THE INVENTION

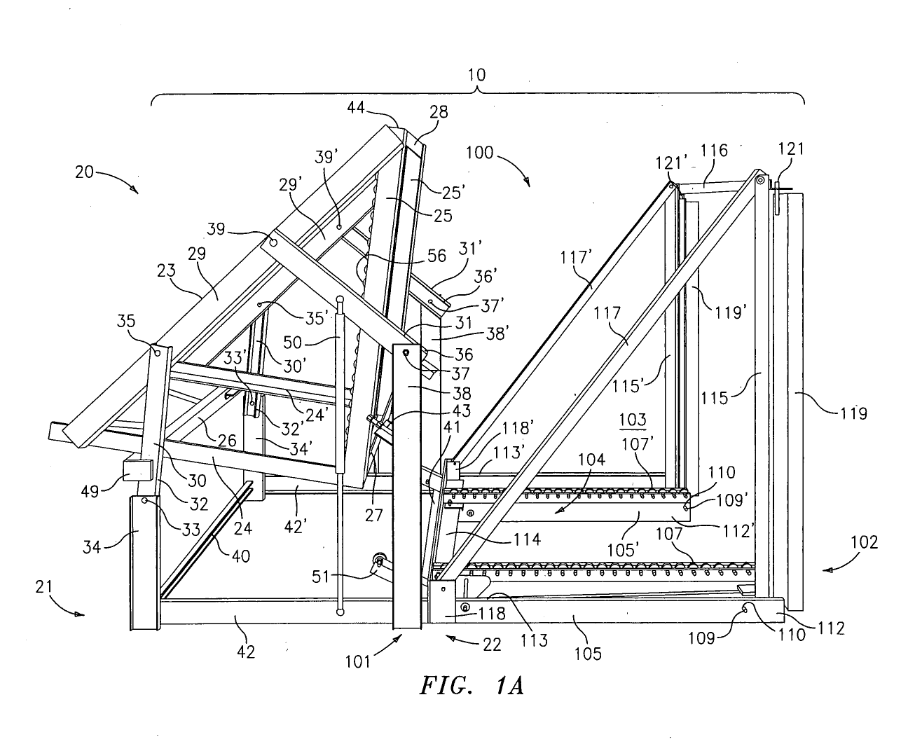

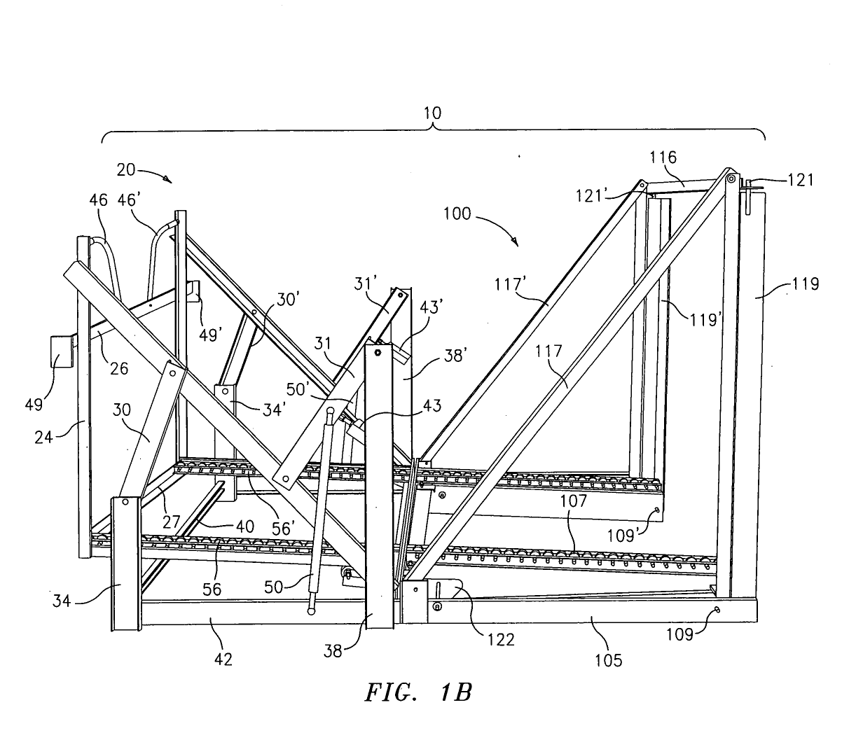

FIGS. 1A and 1B are perspective views of pallet stacking and staging system 10 taken from one side of the system and showing the two terminal positions, or stages, of pallet hopper 23 of pallet stacking unit 20 (upper, or pallet loading and stacking, position in FIG. 1A and lower, or stacked pallet discharging, position in FIG. 1B) and its stacked pallet staging unit 100 (pallet stack retention gate in the open position in FIG. 1A and pallet stack retention gate in the closed position in FIG. 1B). Pallet stacking and staging system 10 is adapted to stack a number of empty pallets in its pallet stacking unit 20 and transfer the stack of empty pallets to its pallet staging unit 100. The term “pallet” as used herein includes not only a pallet in its ordinary or industry-understood sense but any other article which is capable of being formed into a stack. The standard pallet generally possesses dimensions of 48″ length, 40″ width and approximately 5″ height. Pallet stacking unit 20 can be used by itself to stack a quantity of empty pallets and to discharge the stack but is advantageously employed in cooperation with optional stacked pallet staging unit 100 whose stacked pallet receiving end can be temporarily or permanently coupled to the stacked pallet discharge end of pallet stacking unit 20. Stacked pallet staging unit 100 is adapted to receive the stack of empty pallets discharged from pallet stacking unit 20 freeing the latter for stacking another quantity of empty pallets. As and when desired, the stack of pallets retained within the staging bay of stacked pallet staging unit 100 can be removed therefrom by stacked pallet retrieval and transporting equipment, e.g., by an automated guided vehicle (AGV) system, to another location within a warehousing or distribution facility.

Pallet stacking unit 20 takes up little more area than that of a single pallet and when used by itself, i.e., without optional stacked pallet staging unit 100, may be said to be in a “one-deep” (i.e., a one-pallet deep) use configuration. When pallet stacking unit 20 is used in combination with optional stacked pallet staging unit 100, since the latter also takes up an area which is little more than that of a single pallet, the combined units may be said to be in a “two-deep” (i.e., two-pallet deep) use configuration.

Pallet stacking unit 20 and optional stacked pallet staging unit 100 which make up pallet stacking and staging system 10 are constructed of materials, e.g., steel, that will readily withstand the mechanical forces and stresses to which the units can be expected to be subjected during their normal operation.

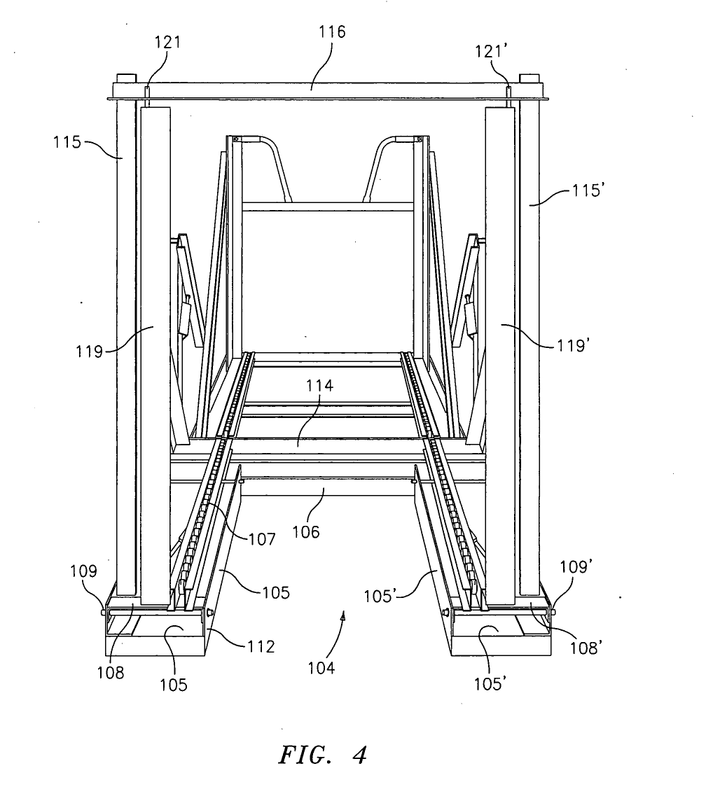

Pallet stacking unit 20 possesses a pallet loading and stacking end 21 and a stacked pallet discharge end 22 and includes a generally L-shaped pallet hopper 23 dimensioned to form and accommodate a stack of empty pallets. Pallet hopper 23 possesses a first pair of flanged legs 24 and 24′ parallel to each other and spaced apart by a distance corresponding to the width of the empty pallets to be stacked. Legs 24 and 24′ are perpendicularly joined to a second pair of legs 25 and 25′ which, like the first pair of legs, are parallel to each other and spaced apart by the same pallet width-defining distance. The length of legs 25 and 25′ and their distance from each other will typically be that which is suitable for accommodating a standard pallet, e.g., one having dimensions of 48″×40″ as previously mentioned. Although the distance separating legs 24 and 24′ from each other is the same as the distance separating legs 25 and 25′, the length of legs 24 and 24′ can be less than, approximately equal to (which is generally preferred) or greater than the length of legs 25 and 25′. The maximum height of a stack of pallets that can be formed in pallet hopper 23 increases with an increase in the length of legs 25 and 25′. In pallet hopper 23, legs 24 and 24′ function to align the pallet stack as the stack is being formed and legs 25 and 25′ function to support the flat base of the pallet stack and to carry more of the weight of the stack as pallet hopper 23 moves to the stacked pallet discharging position. Transverse braces 26, 27 and 28 and a pair of diagonal braces 29 and 29′ maintain the spatial relationships of the first and second pairs of legs and impart rigidity to the overall structure of pallet hopper 23. Edge 44 of transverse brace 28 defines the forward edge of pallet hopper 23 and is oriented toward stacked pallet discharge end 22 of pallet stacking unit 20. The ends of transverse brace 26 extend a short distance beyond legs 24 and 24′ and provide convenient sites of attachment for outwardly flanged plates 49 and 49′ (latter shown in FIG. 4B) the function of which is described below with particular reference to plate 49.

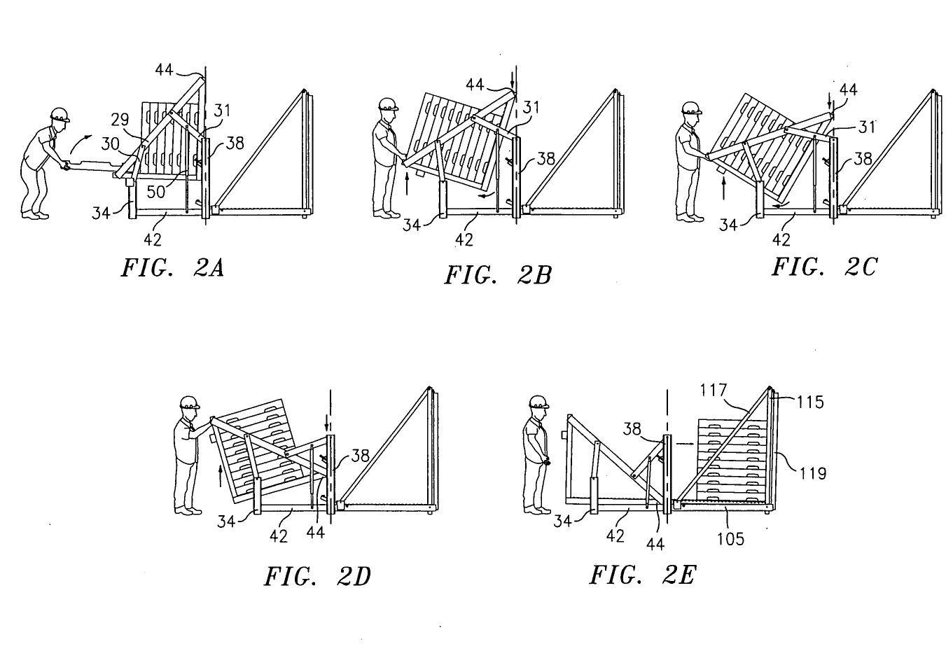

Pallet hopper 23 is moveable from the empty pallet loading/stacking position shown in FIG. 1A to the stacked pallet discharge position shown in FIG. 1B employing a 4-bar linkage consisting of a first pair of bars 30 and 30′ in coacting relationship with a second pair of bars 31 and 31′. Ends 32 and 32′ of the first pair of bars 30 and 30′ are pivotally linked at pivot axes, or points, 33 and 33′ to the upper ends of fixed vertical supports 34 and 34′ and at their opposite ends bars 30 and 30′ are pivotally linked at pivot points 35 and 35′ to diagonal braces 29 and 29′. Ends 36 and 36′ of the second pair of bars 31 and 31′ are pivotally linked at pivot points 37 and 37′ to the upper ends of fixed vertical supports 38 and 38′ and at their opposite ends bars 31 and 31′ are pivotally linked at pivot points 39 and 39′ to diagonal braces 29 and 29′. Transverse braces 40 and 41 and longitudinal rails 42 and 42′ joined to vertical supports 34, 34′, 38 and 38′ provide a fixed rigid frame structure that supports pallet hopper 23 in all of the positions and load conditions of the latter. Alternatively, the fixed rigid frame structure can be modified to suspend pallet hopper 23 from above rather than support the hopper from below as shown in the drawings. In such an embodiment, the geometry of the 4-bar linkage will be such as to provide substantially the same continuous compound motion of pallet hopper 23 shown in FIGS. 2A-2E.

The configuration and dimensions of the fixed rigid frame structure may vary provided the structure provides a stable fixed support for pallet hopper 23 and the 4-bar linkage in all load conditions and positions of the hopper. However, it is preferred that consistent with these requirements, the fixed rigid frame structure occupy the least area practical (as, for example, shown in the drawings) given the typically confined area in which pallet stacking unit 20 will be situated and operated.

When pallet hopper 23 is in the upper, or pallet loading and stacking, position as shown in FIG. 1A, it is oriented at a slight angle of inclination relative to the horizontal in order to maintain the stacked pallet(s) in a somewhat erect position. The angle of inclination is a function of the placement of flanged plates 49 and 49′. In the embodiment shown, the placement of plates 49 and 49′ on first pair of legs 24 and 24′ is such as to provide an angle of inclination relative to the horizontal of about 9-10°. It will, of course, be understood that this angle is not critical and other angles can be utilized that will achieve a comparable result. When pallet hopper 23 is in the lower, or pallet discharging, position as shown in FIG. 1B, second pair of legs 25 and 25′ and roller assemblies, or flow tracks, 56 and 56′ attached thereto are at a slight downward incline relative to the horizontal. This angle, e.g., of about 2-3°, is set and maintained by adjustable stops 43 and 43′ affixed to vertical supports 38 and 38′. Due to this slight downward incline, stacked pallets will gently and smoothly flow under the influence of gravity from pallet hopper 23 into empty staging bay 103 of pallet staging unit 100. When pallet stacking unit 20 is intended to be used by itself, second pair of legs 25 and 25′ may be essentially horizontal when pallet hopper 23 is in the stacked pallet discharging position and flow tracks 56 and 56′ may be omitted.

It will, of course, be recognized that pallet hopper 23 may, in place of the largely open framework structure shown, possess a closed or predominantly closed structure as, e.g., provided by perpendicularly joining the edges of two panels of steel to provide the pallet-accommodating L-shape and/or substituting gussets for the diagonal braces. Similarly, the largely open framework of the fixed supporting structure can be substituted by a closed or predominantly closed structure assembled from steel panels. An open framework structure is generally preferred for its lighter weight which in turn provides for a greater ease of operation of pallet stacking unit 20 particularly where, as here, such operation is carried out manually.

The positions of the pivot points of bars 30, 30′, 31 and 31′ relative to each other are such that transition of pallet hopper 23 from the pallet loading/stacking position shown diagrammatically in FIG. 2A, through the intermediate positions shown diagrammatically in FIGS. 2B, 2C and 2D, and to the stacked pallet discharge position shown diagrammatically in FIG. 2E and vice versa are accomplished by a distinctive continuous compound motion. This compound motion can be visualized by tracking the positions of forward edge 44 of hopper 23 as the hopper moves from the pallet loading and stacking position (FIG. 2A), through its intermediate positions (FIGS. 2B, 2C and 2D) and finally to its stacked pallet discharging position (FIG. 2E). In these phases of its motion, forward edge 44 moves in a nearly vertical line. In so moving, it will be appreciated that forward edge 44 of pallet hopper 23 never breaks the vertical plane defined by the outer edges of fixed vertical supports 38 and 38′ (indicated by the broken line in FIGS. 2A-2E). Specifically, in the 4-bar linkage of pallet stacking unit 20, the distances between consecutive pivot points are substantially equal. Thus, D₁ representing the distance between the pair of pivot points 33 and 33′ and the pair of pivot points 35 and 35′, D₂ representing the distance between the pair of pivot points 35 and 35′ and the pair of pivot points 39 and 39′ and D₃ representing the distance between the pair of pivot points 39 and 39′ and the pair of pivot points 37 and 37′ are substantially equal thereby providing the aforedescribed distinctive compound motion of pallet hopper 23. While other pivot point arrangements can be provided to yield this or a similar motion, the particular 4-bar linkage geometry here has been found to work well for the shape and dimensions of its pallet hopper 23 and fixed supporting frame shown.

If desired, conventional gas springs 50 and 50′ of the cylinder and piston type can be installed, one on each side of pallet stacking unit 20, in order to slow down, or dampen, the motion of pallet hopper 23 as it moves downwardly to the stacked pallet discharging position and to assist its return as it moves upwardly to the pallet loading and stacking position. One end of gas spring 50 is pivotally connected to linkage bar 31 with the other end of the spring being pivotally connected to longitudinal rail 42, gas spring 50′ being mounted in symmetrical fashion to the other side of pallet stacking unit 20.

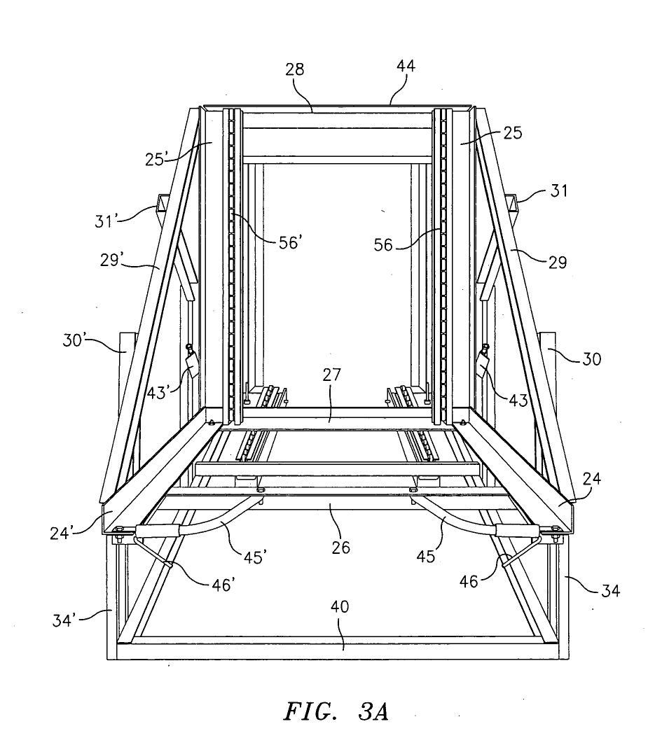

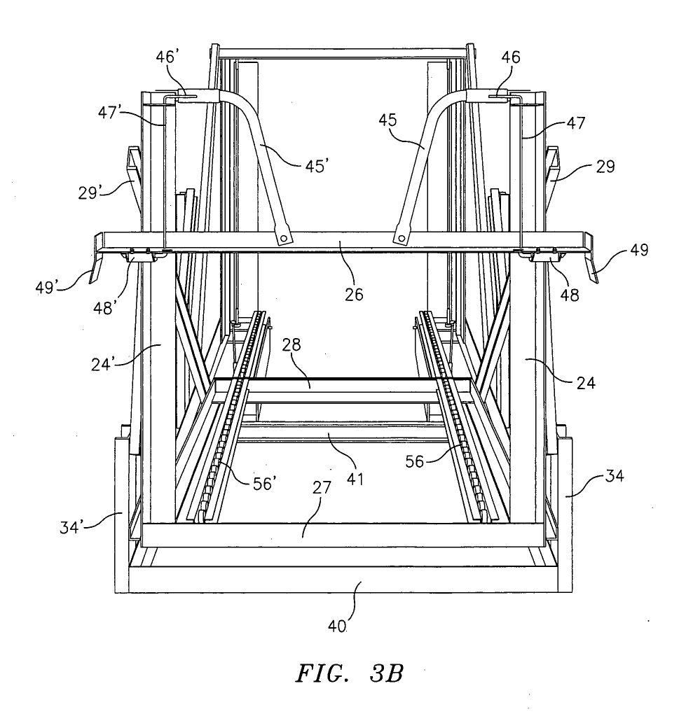

The embodiment of pallet stacking unit 20 illustrated herein is intended for manual operation. To facilitate such operation and as shown in the opposing end views of pallet stacking unit 20 of FIGS. 3A and 3B, pallet hopper 23 possesses a pair of gripping handles 45 and 45′ and a pair of lock actuator levers 46 and 46′ connected to rods 47 and 47′ which control the movement of spring-tensioned locking bolts of locking units 48 and 48′ of conventional design and operation. In the locked position of pallet loader/receiver 23 shown in FIGS. 1A and 3A, outwardly flared plate 49 joined to an end of transverse brace 26 wraps around the lower end of bar 30 and prevents the bar from disengaging from the locking bolt of locking unit 48. Simultaneous upward movement of lock actuator levers 46 and 46′ by the operator releases the locking bolts from their extended, or locked, positions causing pallet hopper 23 to enter into and proceed through its distinctive compound motion culminating in the stacked pallet discharge position of the hopper shown in FIG. 1B.

In lieu of manual operation, pallet stacking unit 20 can be provided with a power source, e.g., one or more electric motors, air motors, hydraulic cylinders, etc., and associated mechanical elements and controls, all of conventional design and operation, to accomplish the movements of pallet hopper 23.

While, as previously stated, pallet stacking unit 20 can be employed by itself in the one-deep use configuration, additional operational benefits may be gained by employing the device together with optional pallet staging unit 100 in the two-deep use configuration shown in all of the figures of drawing herein. In the two-deep configuration, stacked pallet receiving end 101 of stacked pallet staging unit 100 is permanently or detachably coupled to stacked pallet discharge end 22 of pallet stacking unit 20 or is an integral part of the structure of the latter. Thus, after a first group of empty pallets has been stacked in pallet hopper 23 and discharged therefrom directly into stacked pallet staging bay 103 of stacked pallet staging unit 100, the operator can return pallet hopper 23 to its pallet loading and stacking position and commence stacking a second group of empty pallets. Since all of the various operations of pallet stacking and staging system 10, i.e., stacking, discharging, staging and releasing stacked pallets for transportation elsewhere, take place within the confines of a two-pallet deep configuration which in most warehouse and distribution center layouts is the maximum area available, pallet stacking and staging system 10 provides for highly efficient and productive pallet stacking operations while making maximum use of the limited area available. By contrast, the device for stacking empty pallets described in US 2003/0059290 takes up considerably more area than a one-deep pallet configuration due to its pallet receptacle component moving in a circular arc when transitioning from the pallet loading and stacking position to the stacked pallet discharge position. This device therefore cannot be used with a stacked pallet staging unit whose footprint occupies at least an additional one-pallet area. The circular arc defined by the transitional movement of the pallet loading and stacking component of the device described in US 2003/0059290 is a consequence of its possessing a single pivot point. In the case of the empty pallet stacking and staging system of this invention, its unique 4-bar linkage provides a compound motion that economizes the space needed for the transitioning movements of its pallet hopper 23 and makes it possible for the pallet stacking unit to be used in conjunction with the stacked pallet staging unit within a two-pallet deep area.

Referring to FIGS. 1A, 1B, 4, 6A, 6B and 6C, stacked pallet staging unit 100 possesses a stacked pallet receiving end 101 cooperatively coupled to stacked pallet discharge end 22 of pallet stacking unit 20, a stacked pallet removal end 102 and stacked pallet staging bay 103 therebetween dimensioned to receive and retain a stack of pallets until its removal therefrom. Stacked pallet staging unit 100 includes a fixed U-shaped frame 104 made up of a pair of fixed, spaced-apart parallel channels 105 and 105′ joined at one end to transverse brace 106 and open at the other. Within the inner sides of the channels are flow tracks 107 and 107′ attached at one end to pivot plates 108 and 108′ that are pivotally connected by rods 109 and 109′ at pivot points 110 and 110′ to first ends 112 and 112′ of fixed channels 105 and 105′. The other ends of flow tracks 107 and 107′ extend a short distance beyond second ends 113 and 113′ of channels 105 and 105′ and are there joined to transverse brace 114. The lower ends of vertical members, or posts, 115 and 115′ are also fixed to pivot plates 108 and 108′, their upper ends being joined to transverse brace 116 to provide a gate-supporting assembly. Diagonal braces 117 and 117′ are attached at their upper ends to the upper ends of posts 115 and 115′ and at their lower ends to guide plates 118 and 118′ which are fixed to each end of transverse brace 114 and flank the outer sides of channels 105 and 105′. Shutter-like gate members 119 and 119′ proximate to posts 115 and 115′ are pivotally attached at their upper ends to opposite ends 121 and 121′ of transverse brace 116 and are pivotally attached at their lower ends to pivot fixtures 120 and 120′ on pivot plates 108 and 108′. The height of gate members 119 and 119′ will ordinarily be approximately equal in height to the maximum height of a stacked pallet array that can be formed in pallet hopper 23 of pallet stacking unit 20 in order to prevent “shingling”, a result that might otherwise occur were the abrupt halt in the forward momentum of the stacked pallets discharged from pallet hopper 23 to propel one or more pallets in the stack forward. Since the height of gate members 119 and 119′ is approximately that of the tallest possible stack of pallets, none of the stacked pallets can move past the pallet stack retention gate when the gate is in its closed position, thus precluding shingling.

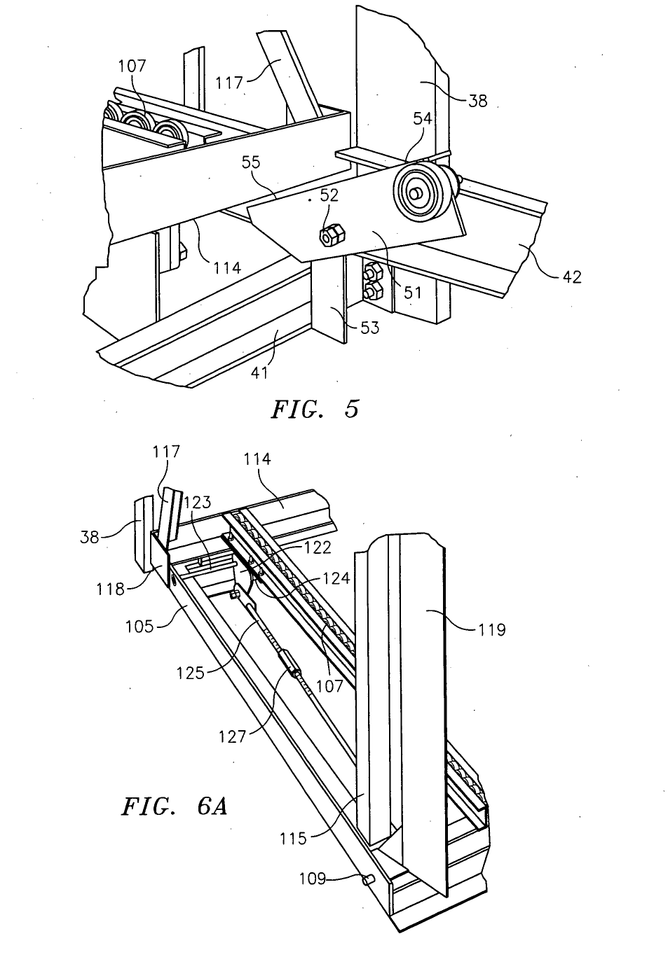

Pallet stacking unit 20 possesses a pair of levers 51 and 51′ one of which is illustrated in detail in FIG. 5. Lever 51 is pivotally attached at pivot point 52 to plate 53 joined to transverse brace 41. When, as shown in FIG. 1B, pallet hopper 23 is in the stacked pallet discharge position, its weight (empty or full) applied to end 54 of lever 51 forces its opposite end 55 which is positioned below transverse brace 114 to pivot upwardly thereby causing flow track 107 which is pivotally connected at pivot point 110 of channel 105 to move upwardly and be brought into substantially linear alignment with identically sloped flow track 56 on flanged leg 25 of pallet hopper 23. The locations of lever 51 and its pivot point 52, as well as the particular configuration of the lever, are not critical provided one end of the lever will be depressed by the weight of pallet hopper 23 when the hopper is in the stacked pallet discharging position causing the other end of the lever to elevate flow track 107 about its pivot point 110. If desired, the lever can be connected in its entirety to stacked pallet staging unit 100 provided it achieves the aforedescribed action.

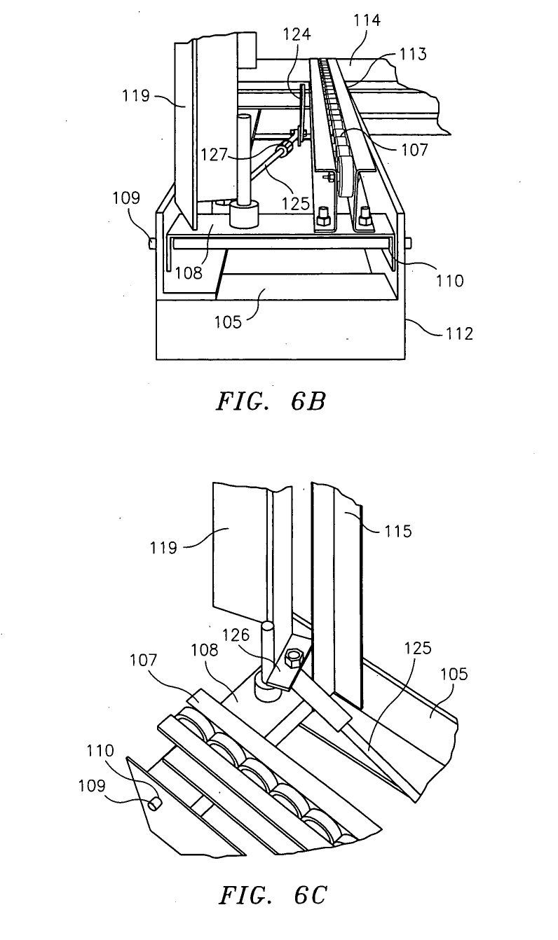

The upward pivotal movement of flow track 107 (and companion flow track 107′) simultaneously accomplishes another action, i.e., that of closing the pallet stack retention gate which is shown in the open position in FIGS. 1A, 6A, 6B and 6C and in the closed position in FIGS. 1B and 4. Details of the pallet stack retention gate and its actuating mechanism are variously shown in FIGS. 1A, 1B, 4, 6A, 6B and 6C to which reference will now be made.

FIGS. 6A, 6B and 6C illustrate one of a pair of identical gate actuating mechanisms associated with the flow track and channel components of pallet staging unit 100. The gate actuating mechanism includes a triangular shaped crank plate 122, the first corner of which is pivotally connected to channel 105 by bar 123, the second corner of which possesses a lifting bar 124 whose free end lies within a pocket or recess on the side or underside of flow track 107 and the third corner of which is pivotally connected to one end of gate actuator rod 125 whose opposite end is pivotally connected to flange 126 at the bottom of gate member 119 (FIG. 6C). The length of gate actuator rod can be adjusted, if desired, by rotation of sleeve nut 127. When, as described above in connection with FIG. 5, the weight of pallet hopper 23 is brought to bear against end 54 of lever 51, opposite end 55 of the lever forces the upward pivotal movement of flow track 107 and its linear alignment with flow track 56. This upward movement of flow track 107 carries with it lifting bar 124 causing crank plate 122 to pivot and gate actuator rod 125 to rotate gate member 119 to the closed position. A stack of pallets in pallet hopper 23 of pallet stacker unit 20 will slowly descend therefrom to staging bay 103 of pallet staging unit 100 where it will be held in check by closed gate members 119 and 119′ (FIG. 2E). When empty pallet hopper 23 returns to the pallet loading and stacking position (FIG. 1A), flow tracks 107 and 107′ (pallet-loaded or not) will return to the horizontal position causing crank plate 122 to pivot and gate actuator bar to rotate gate member 119 to the open position permitting access to the stacked pallets by pallet transporting equipment. Since posts 115 and 115′ and their associated gates members 119 and 119′ share a common pivot with flow tracks 107 and 107′, the posts and gates regardless of their orientation with respect to the horizontal (substantially perpendicular in the gate-open position and inclined in the gate-closed position) will always be substantially perpendicular to the flow tracks.

### MODE OF OPERATION OF THE INVENTION

Operation of the empty pallet stacking and staging system 10 of the invention will now be described starting with the system in its pallet loading and stacking position shown in FIGS. 1A and 2A, proceeding with intermediate stages shown in FIGS. 2B, 2C and 2D and ending with the system in its stacked pallet discharging position shown in FIGS. 1B and 2E.

A pallet is placed with its forward edge onto flanged legs 24 and 24′ of hopper 23 and lifted at its rearward edge to pivot into a somewhat upright position whereupon it comes to rest with its flat side abutting flow tracks 54 and 54′ on legs 25 and 25′. After a number of pallets have been loaded and stacked up to the maximum number of which pallet hopper 23 is capable, the operator grips both handles 45 and 45′ and by upward movement of lock actuator levers 46 and 46′ releases the locking bolts which until then have held pallet hopper 23 in the pallet loading and stacking position. With the release of the locking bolts, pallet hopper 23 transitions from its initial loading and stacking position shown in FIGS. 1A and 2A, through its intermediate positions shown in FIGS. 2B, 2C and 2D and to the stacked pallet discharging position shown in FIGS. 1B and 2E. In the latter position, the weight of pallet hopper 23 against levers 51 and 51′ simultaneously lifts flow tracks 107 and 107′ of pallet staging unit 100 into substantially linear alignment with inclined flow tracks 56 and 56′ of pallet hopper 23 and closes gate members 119 and 119′. The stacked pallets in pallet hopper 23 gently flow down and into empty staging bay 103 of stacked pallet staging unit 100 (FIG. 2E). With the discharge of the stacked pallets from pallet stacking unit 20 into stacked pallet staging unit 100, the operator returns pallet hopper 23 to its initial pallet loading and stacking position whereupon flow tracks 107 and 107′ of stacked pallet staging unit 100 return to the horizontal position causing gate members 119 and 119′ to return to the open position allowing access to, and removal of, the stacked pallets from the bay of unit 100.

While several forms of the invention have been shown and described, other forms will now be apparent to those skilled in the art. For example, the dimensions of pallet stacking unit 20 may be modified to accommodate the stacking of nonstandard pallets or articles other than pallets. Therefore, it will be understood that the embodiments shown in the drawings and described above are merely for illustrative purposes and are not intended to limit the scope of the invention which is defined by the claims which follow.

1. An empty pallet stacking unit having a pallet loading and stacking end and a stacked pallet discharge end, the pallet stacking unit comprising a pallet hopper dimensioned to form and accommodate a stack of empty pallets and reversibly moveable from a pallet loading and stacking position to a stacked pallet discharging position, the pallet hopper having a forward edge oriented toward the pallet discharge end of the pallet stacking unit, the pallet hopper being pivotally linked to a fixed support through a 4-bar linkage.

2. The pallet stacking unit of claim 1 wherein the 4-bar linkage provides a compound motion of the pallet hopper, said motion being characterized by a nearly vertical movement of the forward edge of the pallet hopper as the pallet hopper transitions from the pallet loading and stacking position to the stacked pallet discharging position.

3. The pallet stacking unit of claim 1 wherein the pallet hopper is of substantially L-shaped configuration and in its pallet loading and stacking position is oriented at a slight downward incline relative to the horizontal.

4. The pallet stacking unit of claim 1 wherein the 4-bar linkage possesses a first pair of bars disposed on one side of the pallet hopper and a second pair of bars symmetrically disposed on the other side of the pallet hopper, each of the 4 bars being pivotally linked at one of its ends to a pivot point on a fixed support and at the other of its ends to a pivot point on the pallet hopper.

5. The pallet stacking unit of claim 4 wherein the distances between consecutive pivot points on each side of the pallet hopper are substantially equal.

6. The pallet stacking unit of claim 1 wherein the pallet hopper possesses at least one flow track to facilitate discharge of stacked pallets from the pallet hopper when the pallet hopper is in the stacked pallet discharging position, the pallet hopper in its stacked pallet discharging position being oriented at a slight downward incline relative to the horizontal.

7-8. (canceled)

9. The pallet stacking unit of claim 1 including means for dampening the movement of the pallet hopper.

10. The pallet stacking unit of claim 9 wherein the means of dampening the movement of the pallet hopper is at least one gas spring pivotally connected at one of its ends to the fixed support and pivotally connected at the other of its ends to the pallet hopper.

11. The pallet stacking unit of claim 1 further comprising
a stacked pallet staging unit having a stacked pallet receiving end, a stacked pallet removal end and a staging bay therebetween dimensioned to receive and retain a stack of pallets, the stacked pallet receiving end of the stacked pallet staging unit being cooperatively coupled to the stacked pallet discharge end of the empty pallet stacking unit such that when the pallet hopper of the empty pallet stacking unit is in the pallet stack discharging position, the stacked pallets will be discharged from the hopper into the stacked pallet staging bay of the stacked pallet staging unit and be retained in the staging bay until their removal therefrom.

12. (canceled)

13. The pallet stacking unit of claim 11 wherein the 4-bar linkage provides a compound motion of the pallet hopper, said motion being characterized by a nearly vertical movement of the forward edge of the pallet hopper as the pallet hopper transitions from the pallet loading and stacking position to the stacked pallet discharging position.

14. The pallet stacking unit of claim 11 wherein the 4-bar linkage possesses a first pair of bars disposed on one side of the pallet hopper and a second pair of bars symmetrically disposed on the other side of the pallet hopper, each of the 4 bars being pivotally linked at one of its ends to a pivot point on a fixed support and at the other of its ends to a pivot point on the pallet hopper.

15. The pallet stacking unit of claim 14 wherein the distances between consecutive pivot points on each side of the pallet hopper are substantially equal.

16. The pallet stacking of claim 11 wherein the pallet hopper is of substantially L-shaped configuration and in its pallet loading and stacking position is oriented at a slight downward incline relative to the horizontal.

17. The pallet stacking unit of claim 11 wherein the pallet hopper possesses at least one flow track to facilitate discharge of stacked pallets from the pallet hopper when the pallet hopper is in the stacked pallet discharging position the pallet hopper in its stacked pallet discharging position being oriented at a slight downward incline relative to the horizontal.

18-19. (canceled)

20. The pallet stacking unit of claim 11 including means for dampening the movement of the pallet hopper.

21. The pallet stacking unit of claim 20 wherein the means for dampening the movement of the pallet hopper is at least one gas spring pivotally connected at one of its ends to the fixed support and pivotally connected at the other of its ends to the pallet hopper.

22. The pallet stacking unit of claim 17 wherein the stacked pallet staging unit includes a fixed support, at least one flow track and a gate both pivotally connected to the fixed support at a common pivot point positioned at one end of the fixed support, means for raising and lowering the flow track and tilting the gate about their common pivot point and means for closing and opening the gate coordinately with the raising and lowering, respectively, of the flow track.

23. The pallet stacking unit of claim 22 wherein the means for raising the flow track and tilting the gate about their common pivot point is a lever, the lever being actuated by the weight of the pallet hopper bearing against the lever when the pallet hopper is in the stacked pallet discharging position.

24. The pallet stacking unit of claim 23 wherein in the stacked pallet staging unit, the gate includes a gate-supporting assembly, a pair of gate members supported by the gate-supporting assembly and pivotable about their major axes from a gate-closed position which retains the stacked pallets within the staging bay and a gate-open position which permits removal of the stacked pallets from the staging bay unit, and the means for opening and closing the gate includes a pivotable crank pivotally connected to the fixed support, a lifting bar connecting the crank to a flow track, a rod pivotally connected at one end to the crank and pivotally connected at its opposite end to a gate member.

25. The pallet stacking unit of claim 24 wherein in the pallet staging unit, the height of each gate member is approximately that of the tallest stack of pallets that can be accommodated within the staging bay.

26-29. (canceled)
